(19) United States
(12) Patent Application Publication
(10) Pub. No.: US 2015/0102047 A1
(43) Pub. Date: Apr. 16, 2015

(54) VENDING APPARATUS AND PRODUCT VENDING METHOD

(71) Applicant: UTECHZONE CO., LTD., New Taipei City (TW)

(72) Inventors: Chia-Chun Tsou, New Taipei City (TW); Yi-Fan Chen, New Taipei City (TW); Chieh-Yu Lin, New Taipei City (TW)

(73) Assignee: UTECHZONE CO., LTD., New Taipei City (TW)

(21) Appl. No.: 14/166,823

(22) Filed: Jan. 28, 2014

(30) Foreign Application Priority Data
Oct. 15, 2013 (TW) 102137154

(51) Int. Cl. G07F 9/00; G07F 11/00

(52) U.S. Cl. CPC G07F 9/00; G07F 11/00
USPC 221/1; 221/2

(57) ABSTRACT

In duration of operating a vending machine, the vending machine can only provide a consumer with a simple service and cannot interact with the consumer. The vending machine is lack of and interactive feeling capable of catching the consumer's eyes and lets the consumer feeling novel and interesting, so that a sales volume of products cannot be raised. A vending apparatus and a product vending method of the invention can detect a consumer's operation by using a detector and a currency collecting device, and display a corresponding image on a screen according to the consumer's operation. Moreover, delivery of an actual object is in accordance with an image of object delivery, such that the consumer can smoothly feel the interactive feeling when purchasing products. Accordingly, the vending apparatus provides the consumer with a novel and interactive pattern, so as to elevate the consumer's purchase desire.

### CROSS-REFERENCE TO RELATED APPLICATION

This application claims the priority benefit of Taiwan application serial no. 102137154, filed on Oct. 15, 2013. The entirety of the above-mentioned patent application is hereby incorporated by reference herein and made a part of this specification.

### BACKGROUND

1. Technical Field

The invention relates to a vending apparatus, and more particularly relates to a vending apparatus capable of providing an interactive image and a product vending method thereof.

2. Related Art

A commonly used vending machine in the market generally displays products behind a transparent panel of the vending machine to facilitate consumer's selection. The consumer can obtain a product by clicking a physical button corresponding to the product and putting in money. The vending machines bring convenience to consumers, and many product sellers try to sell products through the vending machines.

A common operation method of the vending machine can only provide the consumer simple sales services, though for some of the consumers, such operation method is dull and uninteresting. Therefore, even if the products for sale are diversified, the general vending machine cannot catch consumer's eyes, and a sales volume of the products cannot be raised.

### SUMMARY

The invention is directed to a vending apparatus and a product vending method thereof, which is capable of providing a novel and interactive operation method to raise a purchase desire of the consumer, so as to raise a sales volume of products.

The invention provides a vending apparatus including a currency collecting device, a screen, a detection unit and a processing unit. The processing unit is coupled to the currency collecting device, the screen and the detection unit. The detection unit detects a selection operation of a user performed on a first physical object in the vending apparatus, and the processing unit displays a first multimedia image corresponding the selection operation of the user on the screen. The currency collecting device detects a payment operation of the user performed to the currency collecting device, and the processing unit displays a second multimedia image corresponding to the payment operation of the user on the screen according to the payment operation of the user. Moreover, the processing unit displays a third multimedia image corresponding to delivery of the first physical object on the screen, and the first physical object is delivered in accordance with content of the third multimedia image.

In an embodiment of the invention, the detection unit further detects a distance between the user and the vending apparatus, and when the distance is smaller than a threshold value, the processing unit displays a fourth multimedia image on the screen.

In an embodiment of the invention, the detection unit includes a motion sensor, and the motion sensor is used for detecting the selection operation of the user.

In an embodiment of the invention, the motion sensor includes one of a depth camera, a three-dimensional camera and an RGB camera or a combination thereof.

In an embodiment of the invention, the screen has a transparent display region, and the transparent display region is used for exposing a plurality of physical objects in the vending apparatus.

According to another aspect, the invention provides a product vending method, which includes following steps. A selection operation of a user performed on a first physical object is detected. A first multimedia image corresponding the selection operation of the user is displayed on the screen according to the selection operation of the user. A payment operation of the user is detected. A second multimedia image corresponding to the payment operation of the user is displayed on the screen according to the payment operation of the user. And, a third multimedia image corresponding to delivery of the first physical object is displayed on the screen, and the first physical object is delivered in accordance with content of the third multimedia image.

In an embodiment of the invention, before the step of detecting the selection operation of the user performed on the first physical object, the method further includes following steps. A distance between the user and a motion sensor is detected. Moreover, when the distance between the user and the motion sensor is smaller than a threshold value, a fourth multimedia image corresponding to approaching of the user is displayed on the screen.

In an embodiment of the invention, the step of detecting the selection operation of the user performed on the first physical object includes a following step. A motion sensor is used to detect the selection operation of the user.

In an embodiment of the invention, the motion sensor includes one of a depth camera, a three-dimensional camera and an RGB camera or a combination thereof.

In an embodiment of the invention, after the step of displaying the second multimedia image corresponding to the payment operation of the user on the screen according to the payment operation, the method further includes following steps. A currency examination procedure is performed. Moreover, a fifth multimedia image is displayed on the screen according to the above currency examination procedure.

According to the above descriptions, the processing unit of the vending apparatus of the invention controls to display corresponding multimedia images on the screen according to the selection operation and the payment operation of the user, and the product is delivered along with the corresponding multimedia image. In this way, the vending apparatus of the invention can catch consumer's eyes and provide the consumer with a novel and interactive pattern, so as to elevate the consumer's purchase desire.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a vending apparatus according to an embodiment of the invention.

FIG. 2 is a schematic diagram of a vending apparatus according to an embodiment of the invention.

FIG. 3 is a flowchart illustrating a product vending method according to an embodiment of the invention.

FIG. 4A and FIG. 4B are schematic diagrams of a selection operation of a user according to an embodiment of the invention.

FIG. 5 is a schematic diagram of sensing a distance according to an embodiment of the invention.

FIG. 6 is a schematic diagram of a vending apparatus according to another embodiment of the invention.

### DETAILED DESCRIPTION OF DISCLOSED EMBODIMENTS

In order to catch the consumer's eyes, the invention provides a vending apparatus and a product vending method thereof. The vending apparatus detects a selection operation and a payment operation of the consumer, and displays corresponding images on a screen, and a product is delivered along with a corresponding image. In this way, the consumer may have a novel and interesting interactive experience, and a purchase desire of the consumer is raised. Embodiments complying with the spirit of the invention are provided below for reference, though the invention is not limited to the provided embodiments.

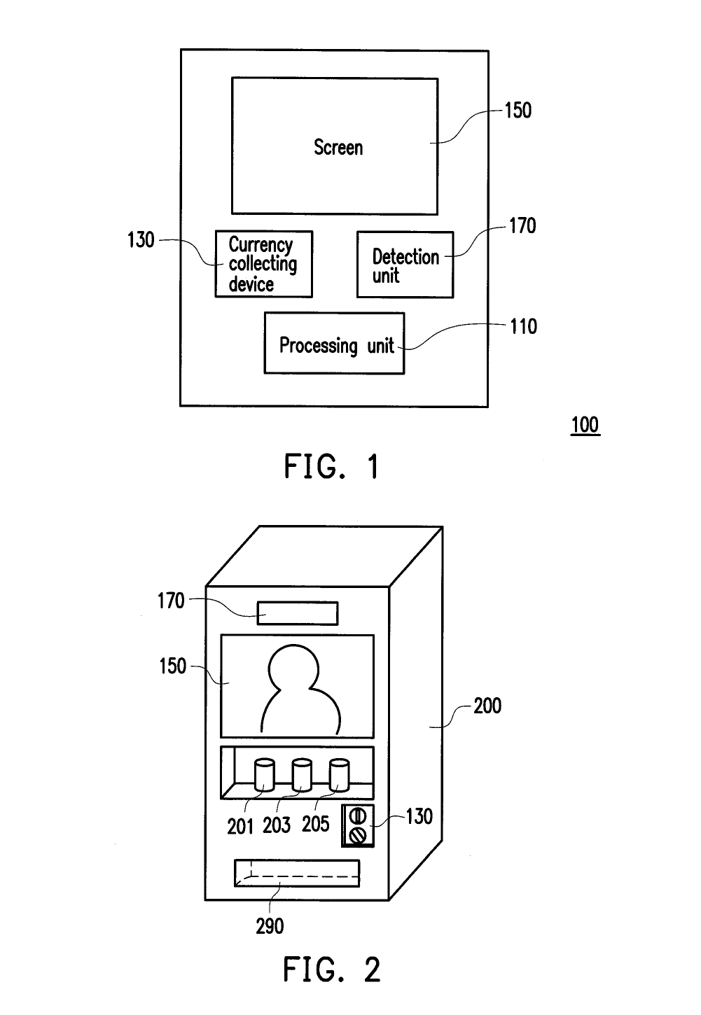

FIG. 1 is a block diagram of a vending apparatus according to an embodiment of the invention. Referring to FIG. 1, the vending apparatus 100 includes a processing unit 110, a currency collecting device 130, a screen 150 and a detection unit 170. The processing unit 170 is coupled to the currency collecting device 130, the screen 150 and the detection unit 170. The processing unit 110 can be a chipset, a microprocessor or a micro control unit (MCU) that has a computing function. The processing unit 110 of the present embodiment is used for processing all tasks of the vending apparatus 100.

The currency collecting apparatus 130 can be one of a collecting apparatus that collects real currency such as coins, tokens and banknotes, etc., a collecting apparatus capable of sensing various electronic tickets, a card reader device and an electronic wallet sensing device, etc. or a combination thereof. The screen 150 can be a liquid crystal display (LCD), an organic electro-luminescent display (OLED) or a plasma display panel (PDP), etc. The detection unit 170 can be one of a motion sensor, a distance sensor, a physical button sensing device, a touch sensing device and an optical rangefinder, or a combination thereof.

In an embodiment of the invention, when a consumer goes to a vending apparatus to buy a product, the consumer probably hesitates in front of a variety of products, and the vending apparatus does not provide the consumer with an interactive service, which decreases a purchase desire of the consumer. In order to catch the consumer's eyes, the vending apparatus 100 of the invention detects an operation of the user through the detection unit 170, and displays an interactive image corresponding to the operation of the user through the screen 150, and displays a multimedia image corresponding to delivery of the product. Therefore, the consumer may experience a novel and interactive consumption pattern, which raises the purchase desire of the consumer.

FIG. 2 is a schematic diagram of a vending apparatus according to an embodiment of the invention. Referring to FIG. 2, the vending apparatus 200 corresponds to the vending apparatus 100 of FIG. 1, and the embodiment of FIG. 2 can be deduced according to related descriptions of FIG. 1. The vending apparatus 200 includes the currency collecting device 130, the screen 150, the detection unit 170, physical objects 201, 203 and 205 and object delivery compartment 290. Types, sizes and positions of various devices, units, and objects of FIG. 2 are only used as an example, and the types, sizes and positions can be different in other embodiments. The screen 150 may display advertising images (promotion activities, new product release, enterprise images, etc.), and a virtual attendant, etc.

A product vending method of the invention is described below to provide the consumer with a novel and interactive consumption pattern, so as to raise the purchase desire of the consumer.

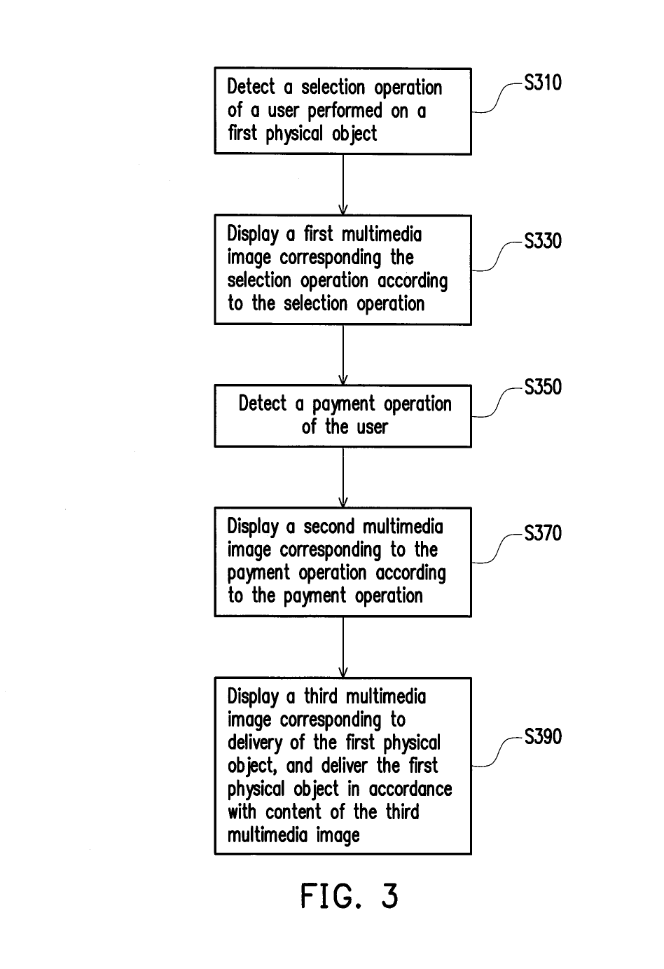

FIG. 3 is a flowchart illustrating a product vending method according to an embodiment of the invention. Referring to FIG. 3, the product vending method of the present embodiment is adapted to the vending apparatus 100 of FIG. 1 and the vending apparatus 200 of FIG. 2. The product vending method of the present embodiment is described below with reference of various components of the vending apparatus 100 of FIG. 1 and the vending apparatus 200 of FIG. 2. The steps of the method can be adjusted according to an actual implementation, which are not limited by the invention.

In step S310, the detection unit 170 detects a selection operation of a user performed on a first physical object in the vending apparatus 200. In step S330, the processing unit displays a first multimedia image corresponding the selection operation of the user on the screen 150 according to the selection operation. In the present embodiment, the detection unit 170 includes a motion sensor, and the motion sensor is used for sensing the selection operation of the user. The motion sensor includes one of a depth camera, a three-dimensional camera and a RGB camera, or a combination thereof.

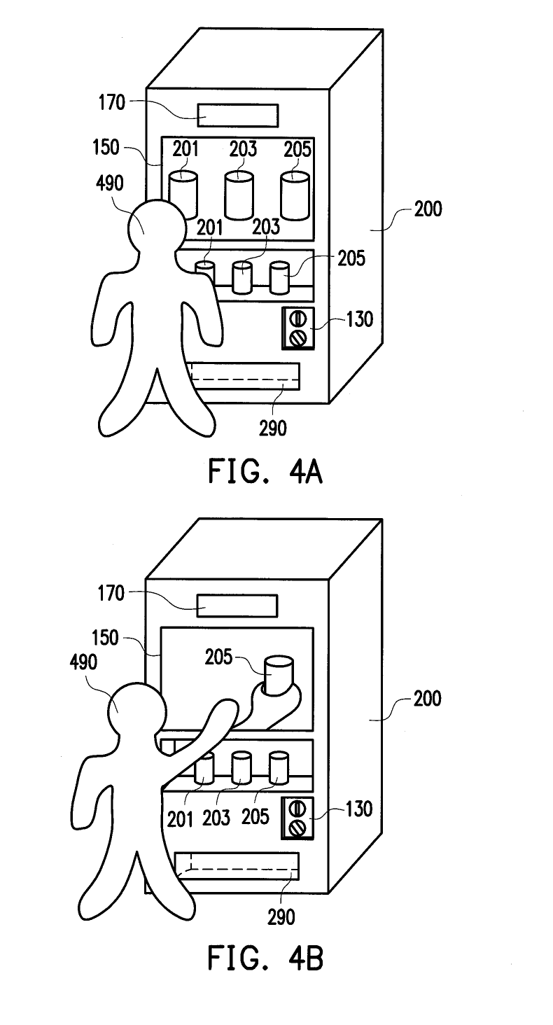

For example, FIG. 4A and FIG. 4B are schematic diagrams of a selection operation of the user according to an embodiment of the invention. Description of the vending apparatus 200 of FIG. 4A and FIG. 4B may refer to related descriptions of FIG. 1 and FIG. 2. Referring to FIG. 4A, the screen 150 displays an image corresponding to the physical objects 201, 203 and 205, and such image can be a promotion advertising, an object composition, a 3D image, etc. of the physical objects, which is not limited by the invention.

Referring to FIG. 4B, the user 490 selects the physical object 205, and the screen 150 displays a multimedia image with a virtual hand lifting the physical object 205. In detail, the processing unit 110 analyzes the selection operation to obtain analysis data by using an image recognition technique or a 3D depth analysis technique according to the selection operation detected by the motion sensor, and compares the obtained analysis data in a database to determine whether the analysis data corresponds to a selection motion. For example, when the five fingers of the user grip inwards to form a fist, the processing unit 110 determines the motion of the user to be the selection motion.

Besides determining whether the user 490 selects the physical object 205 by detecting a grip motion of the user 490, in an embodiment, the detection unit 170 can also detects a specified selection motion of the user 490. For example, the detection unit 170 detects that the user 490 lifts the hand and points to the screen 150 (for example, detects a pointing direction of a finger or arm), the processing unit 110 calculates a position where the user 490 points to the screen 150 according to a direction that the user 490 points to the screen 150, and displays an indicator (for example, a icon, a dot, etc.) corresponding to the pointing position of the user on the screen 150. When the detection unit 170 detects that that the pointing position of the user corresponds to the physical object 205 on the screen 150, or the pointing position stays on the physical object 205 on the screen 150 for a period of time (for example, 0.5 second, 1 second, etc.), the processing unit 110 determines that the user 490 selects the physical object 205. However, the above descriptions is only an example of detecting the selection motion, and in other embodiments, the detection of the selection motion can be implemented according to a different technique or steps, which is not limited by the invention.

By detecting the above selection motion, the selection operation is performed according to the physical object 201, 203 or 205 in the image displayed on the screen 150. In the present embodiment, the step that the processing unit 110 determines the selection operation is not limited thereto, and the motion sensor can detect the selection operation by using any motion sensing technique.

In other embodiments, the detection unit 170 of the vending apparatus 200 can also be a physical button sensing device, and each physical button corresponding to a physical object, and when the user presses the physical button, the detection unit 170 determines the physical object selected by the user. Moreover, the detection unit 170 of the vending apparatus 200 can also be a touch sensing device, where the touch sensing device can be embedded in the screen 150 or embedded in the vending apparatus 200 at any position suitable for the selection operation of the user, and the touch sensing device embedded in the screen 150 may correspond to the image displayed by the screen 150. When the user touches a position on the touch sensing device, the touch sensing device can recognize the physical object corresponding to such position.

In step S350, the currency collecting device 130 detects a payment operation of the user performed to the currency collecting device 130. For example, the vending apparatus 200 may display selling prices of the physical objects 201, 203 and 205 at any position around the physical objects 201, 203 and 205, or display the selling prices on the screen 150. In the present embodiment, the currency collecting device 130 has a currency sensing unit. The currency collecting device 130 may sense an inserting operation, an approaching operation or a card swiping operation of one of a coin, a token, a banknote, an e-ticket, a credit card, an electronic wallet, or a combination thereof.

In step S370, the processing unit 110 displays a second multimedia image corresponding to the payment operation on the screen 150 according to the payment operation. For example, in the step S350, the currency collecting device 130 detects that the user inserts ten coins, and the screen 150 displays a multimedia image indicating that a virtual attendant is bowing or is counting money in response to the insertion operation of the user, such that the user may has a feeling that a real attendant is collecting money. In other embodiments, the currency collecting device 130 can also sense an approaching operation of an e-ticket, and displays a multimedia image corresponding to the approaching operation on the screen 150 in response to the approaching operation of the e-ticket. For example, a multimedia image related to a deduction amount, or a balance of the e-ticket. However, the aforementioned embodiment is only an example of the payment operation and the corresponding image displayed on the screen 150, and the type of the payment operation and the displayed image are not limited by the invention.

In an embodiment of the invention, the currency collecting device 130 further executes a currency examination procedure, and the processing unit 110 displays a fifth multimedia image according to the currency examination procedure. For example, the currency collecting device may detect an amount of money, a number of coins or an identity of credit card inserted by the user. The screen 150 displays a multimedia image indicating the inserted amount of money or indicating that the virtual attendant is counting money.

In step S390, the processing unit 110 displays a third multimedia image corresponding to delivery of the first physical object on the screen 150, and the first physical object is delivered in accordance with content of the third multimedia image. In detail, when the currency collecting device 130 calculates that the amount of money inserted by the user is greater than or equal to the price of the first physical object, the processing unit 110 selects a multimedia image corresponding to delivery of the first physical object, and the screen 150 displays the multimedia image corresponding to delivery of the first physical object. The processing unit 110 controls internal machinery of the vending apparatus 200 to deliver the first physical object to the object delivery compartment 290, and the multimedia image of delivering the first physical object is in accordance with the operation of delivering the first physical object to the object delivery compartment 290.

For example, the product sold by the vending apparatus 200 is coffee, and after the user inserts a correct amount of money, the screen 150 displays a multimedia image of brewing coffee or playing foam, and when the coffee is actually delivered to the object delivery compartment 290, the screen 150 displays a multimedia image of completing making coffee in response to delivery of the coffee. The product sold by the vending apparatus 200 can also be canned beverage, and when the user inserts a correct amount of money, the screen 150 displays a multimedia image indicating that the canned beverage drops to the object delivery compartment 290. Moreover, when the screen 150 displays the multimedia image indicating that the canned beverage drops to the object delivery compartment 290, the canned beverage actually drops to the object delivery compartment 290. However, the sold product of the invention and the corresponding delivery image are not limited to the aforementioned example, and the sold product and the corresponding delivery image can be adjusted by related personnel implementing the invention.

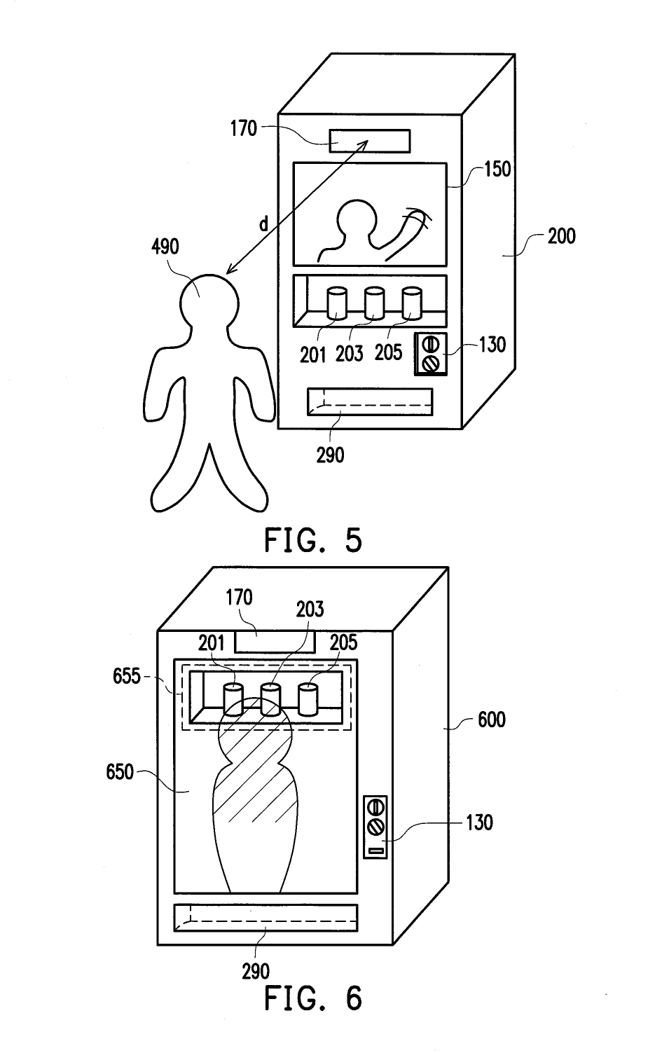

Moreover, in an embodiment of the invention, the detection unit 170 can also detect a distance between the user and the vending apparatus 200 or between the user and the detection unit 170 of the vending apparatus 200, and the processing unit 110 displays a corresponding image on the screen 150 according to the distance. For example, FIG. 5 is a schematic diagram of sensing a distance according to an embodiment of the invention. Description of the vending apparatus 200 of FIG. 5 may refer to related descriptions of FIG. 1 and FIG. 2. Referring to FIG. 5, the detection unit 170 detects a distance d between the user 490 and the vending apparatus 200. The detection unit 170 may have a binocular camera, an optical rangefinder or a distance sensor, etc. for detecting the distance between the detection unit 170 and the user 490. When the distance d detected by the detecting unit 170 is smaller than a threshold value, the processing unit 110 displays a fourth multimedia image on the screen 150. For example, the processing unit 110 controls the screen 150 to display a multimedia image indicating that a virtual attendant says hello, or controls the screen 150 to display promotional products to attract the user 490. In some embodiments, the processor 110 can also control the screen 150 to display operation guiding images to guide the user 490 to operate the vending apparatus 200.

In the aforementioned embodiment, the screen 150 and the displayed physical objects 201, 203 and 205 are respectively disposed at different locations in the vending apparatus 200, while in other embodiments of the invention, the screen and the physical object 201, 203 and 205 can also be overlapped at a same location of the vending apparatus 200. For example, FIG. 6 is a schematic diagram of a vending apparatus according to another embodiment of the invention. Descriptions of the vending apparatus 600 of FIG. 6 may refer to related descriptions of FIG. 1 and FIG. 2. Referring to FIG. 6, the screen 650 has a transparent display region 655, and the transparent display region 655 is used for exposing the physical objects 201, 203 and 205 in the vending apparatus 600. Based on a rear projection technique, and a transparent display technique of removing a backlight plate and adjusting polarized light and liquid crystal molecules, etc., the transparent display region 655 can display images, and meanwhile a background behind the screen can be viewed. For example, the user selects to purchase the physical object 201, and a machinery mechanism in the vending apparatus 600 controls a movement of the physical object 201, and the transparent display region 655 displays a dynamic image of moving the physical object 201. In this way, in collaboration with the image content in the screen 650 and the physical objects 201, 203 and 205, the user may have an interactive feeling when purchasing the product. However, the position, number and size of the transparent display region 655 can be different in different embodiments, and the transparent display region 655 of the present embodiment is not limited thereto.

In summary, the processing unit of the vending apparatus of the invention controls to display corresponding multimedia images on the screen according to the selection operation and the payment operation of the user, and the product is delivered along with the corresponding multimedia image. In this way, the vending apparatus of the invention can catch consumer's eyes and provide the consumer with a novel and interactive pattern, so as to elevate the consumer's purchase desire.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A vending apparatus, comprising:
a currency collecting device;
a screen;
a detection unit; and
a processing unit, coupled to the currency collecting device, the screen and the detection unit,
wherein the detection unit detects a selection operation of a user performed on a first physical object in the vending apparatus, and the processing unit displays a first multimedia image corresponding the selection operation on the screen according to the selection operation, the currency collecting device detects a payment operation of the user performed to the currency collecting device, and the processing unit displays a second multimedia image corresponding to the payment operation on the screen according to the payment operation, and the processing unit displays a third multimedia image corresponding to delivery of the first physical object on the screen, and the first physical object is delivered in accordance with content of the third multimedia image.

2. The vending apparatus as claimed in claim 1, wherein the detection unit further detects a distance between the user and the vending apparatus, and when the distance is smaller than a threshold value, the processing unit displays a fourth multimedia image on the screen.

3. The vending apparatus as claimed in claim 1, wherein the detection unit comprises:
a motion sensor, detecting the selection operation of the user.

4. The vending apparatus as claimed in claim 2, wherein the motion sensor comprises one of a depth camera, a three-dimensional camera and an RGB camera or a combination thereof.

5. The vending apparatus as claimed in claim 1, wherein the screen has a transparent display region for exposing a plurality of physical objects in the vending apparatus.

6. The vending apparatus as claimed in claim 1, wherein the currency collecting device further performs a currency examination procedure, and the processing unit displays a fifth multimedia image on the screen according to the currency examination procedure.

7. A product vending method, comprising:
detecting a selection operation of a user performed on a first physical object;
displaying a first multimedia image corresponding the selection operation on the screen according to the selection operation;
detecting a payment operation of the user;
displaying a second multimedia image corresponding to the payment operation on the screen according to the payment operation; and
displaying a third multimedia image corresponding to delivery of the first physical object on the screen, and delivering the first physical object in accordance with content of the third multimedia image.

8. The product vending method as claimed in claim 7, wherein before the step of detecting the selection operation of the user performed on the first physical object, the method further comprises:
detecting a distance between the user and a motion sensor; and
displaying a fourth multimedia image corresponding to approaching of the user on the screen when the distance is smaller than a threshold value.

9. The product vending method as claimed in claim 7, wherein the step of detecting the selection operation of the user performed on the first physical object comprises:
using a motion sensor to detect the selection operation.

10. The product vending method as claimed in claim 8, wherein the motion sensor comprises one of a depth camera, a three-dimensional camera and an RGB camera or a combination thereof.

11. The product vending method as claimed in claim 7, wherein after the step of displaying the second multimedia image corresponding to the payment operation on the screen according to the payment operation, the method further comprises:
performing a currency examination procedure; and
displaying a fifth multimedia image on the screen according to the currency examination procedure.
